(19) United States
(12) Patent Application Publication
(10) Pub. No.: US 2007/0218096 A1
(43) Pub. Date: Sep. 20, 2007

(54) Medical equipment and methods of making and using the same

(76) Inventor: Debbie Wooley, (US)

Correspondence Address: WITHERS & KEYS, LLC, P. O. BOX 2049, MCDONOUGH, GA, 30253, US

(21) Appl. No.: 11/724,118

(22) Filed: Mar. 14, 2007

Related U.S. Application Data
(60) Provisional application No. 60/782,123, filed on Mar. 14, 2006.

(51) Int. Cl. A01N 25/34

(52) U.S. Cl. 424/411; 600/490

(57) ABSTRACT

Medical equipment for use in an operating room setting, a hospital, or any other medical facility is disclosed. Methods of making and using medical equipment are also disclosed.

### CROSS-REFERENCE TO RELATED APPLICATIONS

This patent application claims the benefit of priority to U.S. Provisional Patent Application Ser. No. 60/782,123 entitled “Medical Equipment and Methods of Making and Using the Same”, filed on Mar. 14, 2006, the subject matter of which is incorporated herein in its entirety

### FIELD OF THE INVENTION

The present invention relates generally to medical equipment suitable for use in operating rooms, hospitals or any medical facility. The present invention further relates to methods of making medical equipment, and methods of using medical equipment in an operating room setting, a hospital, or any other medical facility.

### BACKGROUND OF THE INVENTION

Medical equipment is used in operating rooms, hospitals, and other medical facilities for a variety of purposes. During use, the medical equipment is potentially exposed to body fluids and other contaminants. Efforts continue in the design of medical equipment so as to minimize contamination of the medical equipment from exposure to body fluids and other contaminants, as well as to minimize the transfer of contaminants from the medical equipment to other surfaces such as the surface of another piece of equipment or a patient.

What is needed in the art is medical equipment having improved anti-microbial properties for use in an operating room setting, a hospital, or any other medical facility.

### SUMMARY OF THE INVENTION

The present invention is directed to medical equipment suitable for use in an operating room setting, a hospital, or any other medical facility. The medical equipment of the present invention possesses superior anti-microbial properties due to the presence of at least one anti-microbial material along an outer surface of the medical equipment.

According to one exemplary embodiment of the present invention, the medical equipment comprises a piece of durable medical equipment suitable for use in an operating room setting, a hospital, or any other medical facility, wherein the piece of durable medical equipment has an outer surface that is exposed to body fluids and other fluids when the piece of durable medical equipment is in an operating room setting, a hospital, or any other medical facility, wherein the outer surface comprises a polymeric matrix material and at least one anti-microbial agent within the polymeric matrix material, wherein the at least one anti-microbial agent is selected from the group consisting of a Ag-containing compound, a Cu-containing compound, or combinations thereof. In one exemplary embodiment, the piece of durable medical equipment comprises a compression sleeve pump suitable for use in the treatment of deep vein thrombosis (DVT).

According to a further exemplary embodiment of the present invention, the medical equipment comprises a compression sleeve pump suitable for use in an operating room setting, a hospital, or any other medical facility, wherein the compression sleeve pump has an outer surface that is exposed to body fluids and other fluids when the compression sleeve pump is in an operating room setting, a hospital, or any other medical facility, wherein the outer surface comprises at least one anti-microbial agent. The compression sleeve pump may be used alone or as part of a kit. In one exemplary embodiment, a kit of the present invention comprising the above-mentioned compression sleeve pump in combination with one or more additional pieces of durable medical equipment, wherein the one or more additional pieces comprise at least one compression sleeve, at least one foot sleeve, first tubing suitable for connecting the compression sleeve pump to the at least one compression sleeve, second tubing suitable for connecting the compression sleeve pump to the at least one foot sleeve, tubing connectors, or any combination thereof.

The present invention is further directed to methods of making medical equipment. In one exemplary embodiment of the present invention, the method of making medical equipment comprises the steps of forming at least one component of the piece of durable medical equipment, the at least one component having an outer surface that is exposed to body fluids and other fluids when the piece of durable medical equipment is in an operating room setting, a hospital, or any other medical facility, wherein the outer surface comprises a polymeric matrix material and at least one anti-microbial agent within the polymeric matrix material, the at least one anti-microbial agent being selected from the group consisting of a Ag-containing compound, a Cu-containing compound, or combinations thereof; and if the piece of durable medical equipment has additional components, assembling the at least one component and the additional components so that the outer surface of the piece of durable medical equipment is exposed to body fluids and other fluids when the piece of durable medical equipment is in an operating room setting, a hospital, or any other medical facility.

The present invention is even further directed to methods of using medical equipment in an operating room setting, a hospital, or any other medical facility. In one exemplary embodiment of the present invention, the method comprises introducing the piece of durable medical equipment into an operating room setting, a hospital, or any other medical facility; and utilizing the piece of durable medical equipment to provide a function to a patient. One exemplary function comprises treating deep vein thrombosis (DVT) using a kit comprising the above-mentioned compression sleeve pump in combination with one or more additional pieces of durable medical equipment, wherein the one or more additional pieces comprise at least one compression sleeve, at least one foot sleeve, first tubing suitable for connecting the compression sleeve pump to the at least one compression sleeve, second tubing suitable for connecting the compression sleeve pump to the at least one foot sleeve, tubing connectors, or any combination thereof.

These and other features and advantages of the present invention will become apparent after a review of the following detailed description of the disclosed embodiments and the appended claims.

### BRIEF DESCRIPTION OF THE FIGURES

The present invention is further described with reference to the appended figures, wherein:

FIG. 1 depicts a view of an exemplary kit containing various pieces of medical equipment of the present invention;

FIG. 2A depicts an exemplary cross-sectional view of pump 11 of FIG. 1 along line A-A;

FIG. 2B depicts another exemplary cross-sectional view of pump 11 of FIG. 1 along line A-A;

FIG. 3A depicts an exemplary cross-sectional view of tubing 15 of FIG. 1 along line B-B; and

FIG. 3B depicts another exemplary cross-sectional view of tubing 15 of FIG. 1 along line B-B.

### DETAILED DESCRIPTION OF THE INVENTION

The present invention is directed to medical equipment for use in an operating room setting, a hospital, or any other medical facility. The present invention is further directed to methods of making and using medical equipment in an operating room setting, a hospital, or any other medical facility so as to minimize the transfer of contaminants within the operating room setting, hospital, or other medical facility.

As used herein, the term “Durable Medical Equipment” or “DME” is used to describe a class of products suitable for use in an operating room setting or similar environment (e.g., an operating room setting, a hospital, or any other medical facility). This class of products includes devices, controls, or appliances that enable a patient to increase their ability to perform activities of daily living, or to perceive, control or communicate with the environment in which the patient lives. This class of products also includes items necessary for life support, ancillary supplies and equipment necessary for the proper functioning of items such as life support equipment. Suitable pieces of durable medical equipment include, but are not limited to, hospital beds, walkers, wheel chairs and oxygen tents; pumps such as compression pumps, sequential pumps, DVT (deep vein thrombosis) pumps, intermittent compression pumps, pain pumps, and infusion pumps; and other equipment such as electrocautery equipment, dialysis equipment, ventilators, portable X-ray equipment, portable EKG machines, passive range of motion devices, and nursing drug carts.

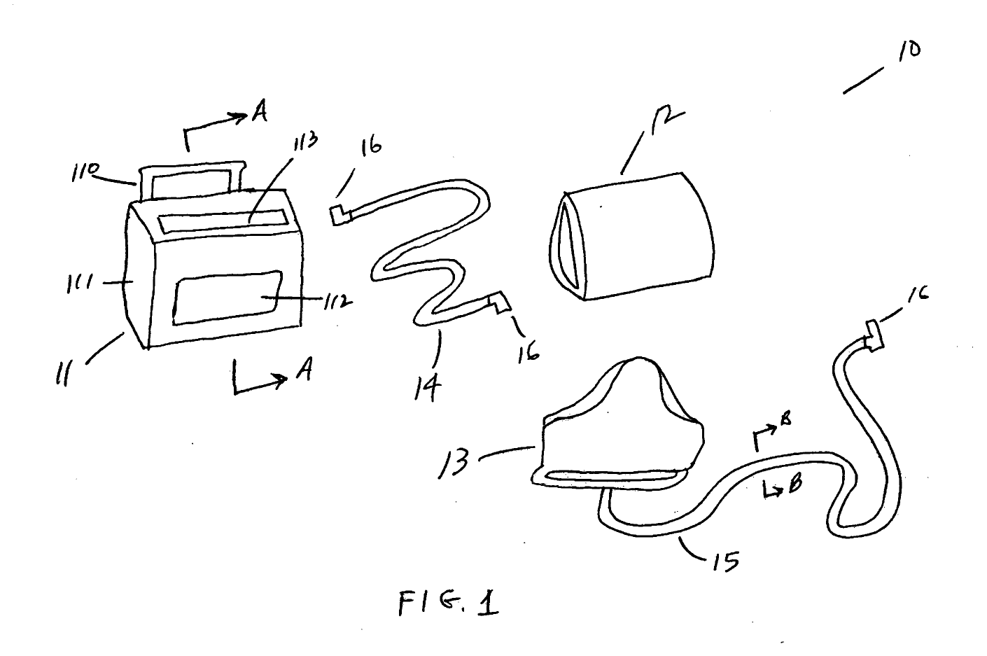

A variety of pieces of durable medical equipment of the present invention is shown in FIG. 1. As shown in FIG. 1, exemplary kit 10 comprises the following exemplary pieces of durable medical equipment: compression sleeve pump 11, compression sleeve 12, foot sleeve 13, first tubing 14 suitable for connecting compression sleeve pump 11 to compression sleeve 12, second tubing 15 suitable for connecting compression sleeve pump 11 to foot sleeve 13, and tubing connectors 16.

Any one or all of the above-mentioned exemplary pieces of durable medical equipment in kit 10 may comprise an anti-microbial agent on at least an outer surface thereof. In some embodiments, the anti-microbial agent is present primarily on an outer surface of the piece of durable medical equipment without extending into a thickness of the piece of durable medical equipment. In other embodiments, the anti-microbial agent is present throughout a thickness of the piece of durable medical equipment from an outer surface thereof to an inner surface thereof.

As shown in FIG. 1, the present invention is directed to a variety of pieces of durable medical equipment. A description of features of exemplary pieces of durable medical equipment of the present invention is provided below.

I. Durable Medical Equipment

The pieces of durable medical equipment of the present invention come in a variety of shapes and sizes. Regardless of the shape or size, each piece of durable medical equipment of the present invention possesses piece components and piece configurations that enable superior anti-microbial properties on an outer surface thereof.

A. Durable Medical Equipment Components

The various pieces of durable medical equipment of the present invention may comprise one or more of the following components.

1. Outer Surface

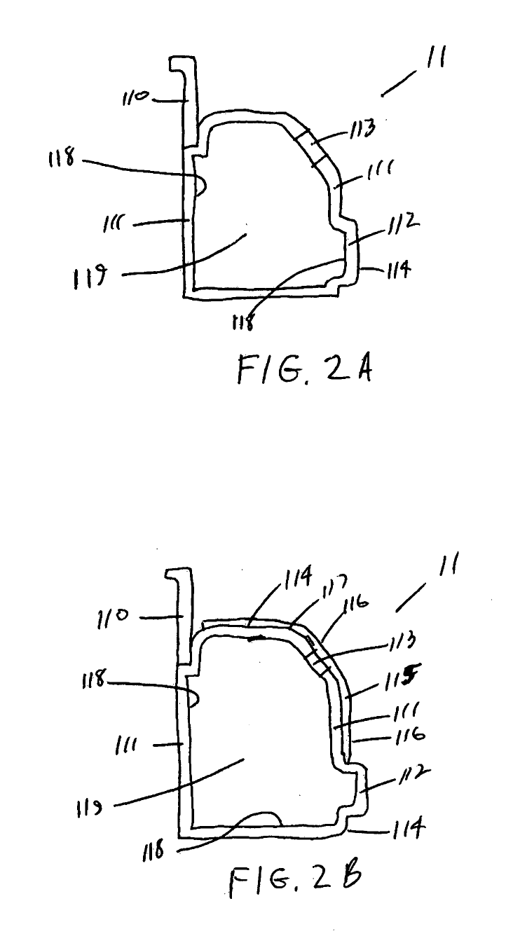

Each piece of durable medical equipment of the present invention has an outer surface that is exposed to body fluids and other fluids when the piece of durable medical equipment is in an operating room setting, a hospital, or any other medical facility. In some embodiments of the present invention, the piece of durable medical equipment comprises inner piece components within an outer housing, wherein the outer housing comprises a thermoformed polymeric structure comprising the outer surface and an inner surface facing the inner piece components of the piece of durable medical equipment. Exemplary compression sleeve pump 11 shown in FIGS. 1-2 is an example of such a piece of durable medical equipment.

As shown in FIG. 1, exemplary compression sleeve pump 11 comprises outer housing 111, bedrail hanger 110 (enabling the convenience of hanging pump 111 on a bedrail), door 112 (providing access to controls), and display 113. One exemplary cross-sectional view of outer housing 111 of exemplary compression sleeve pump 11 along line A-A is provided in FIG. 2A.

As shown in FIG. 2A, outer housing 111 surrounds space 119 in which inner pump components (not shown) would normally be seen. For exemplary compression sleeve pump 11, inner pump components would include, but are not limited to, mechanical components such as a pump for producing pressurized air, and controls; and electrical components such as electronics, display components, and wiring. In this exemplary embodiment, outer housing 111 comprises a thermoformed polymeric structure comprising outer surface 114 and an inner surface 118 facing the inner piece and space 119 of exemplary compression sleeve pump 11. Outer housing 111 can have at least one anti-microbial agent distributed throughout a thickness of the thermoformed polymeric structure extending from outer surface 114 to inner surface 118. In other embodiments, outer housing 111 has at least one anti-microbial agent along outer surface 114, but inner surface 118 of outer housing 111 is substantially free of an anti-microbial agent.

Another exemplary cross-sectional view of outer housing 111 of exemplary compression sleeve pump 11 along line A-A is shown in FIG. 2B. In this exemplary embodiment, pump 11 comprises a thermoformed polymeric structure in the form of a film 115 extending along an outer portion (i.e., surface 114) of outer housing 111 so as to form outer surface 116. In this exemplary embodiment, outer housing 111 of exemplary compression sleeve pump 11 may be substantially free of an anti-microbial agent, and instead be shielded from microorganisms by film 115. Film 115 can have at least one anti-microbial agent distributed throughout a thickness of the thermoformed polymeric structure extending from outer surface 116 to inner surface 117 of film 115. In other embodiments, both outer housing 111 and film 115 have at least one anti-microbial agent so that anti-microbial agent extends from outer surface 116 of film 115 to inner surface 118 of outer housing 111.

It should be noted that in both of the exemplary embodiments shown in FIGS. 2A-2B, outer components of exemplary compression sleeve pump 11 may also contain an anti-microbial agent. For example, bedrail hanger 110 may be a thermoformed polymeric structure comprising a polymeric matrix material and at least one anti-microbial agent distributed throughout the polymeric matrix material. Alternatively, film 115 may be used to cover outer surfaces of bedrail hanger 110 similar to outer housing 111 shown in FIG. 2B.

2. Outer Housing

As discussed above, some pieces of durable medical equipment, such as a compression sleeve pump, comprise an outer housing suitable for enclosing inner piece components. In some embodiments, the outer housing forms an outer surface of the piece of durable medical equipment (see, for example, FIG. 2A). In other embodiments, at least a portion of the outer housing is covered with a film to provide anti-microbial protection to the piece of durable medical equipment (see, for example, FIG. 2B).

3. Inner Piece Components

As discussed above, some pieces of durable medical equipment, such as a compression sleeve pump, comprise inner piece components enclosed within an outer housing. In other pieces of durable medical equipment of the present invention, the piece of durable medical equipment does not comprise any inner piece components due to the simplicity of construction of the piece of durable medical equipment. Examples of pieces of durable medical equipment that do not comprise any inner piece components include, but are not limited to, first tubing 14 suitable for connecting compression sleeve pump 11 to compression sleeve 12, second tubing 15 suitable for connecting compression sleeve pump 11 to foot sleeve 13, and tubing connectors 16 shown in FIG. 1.

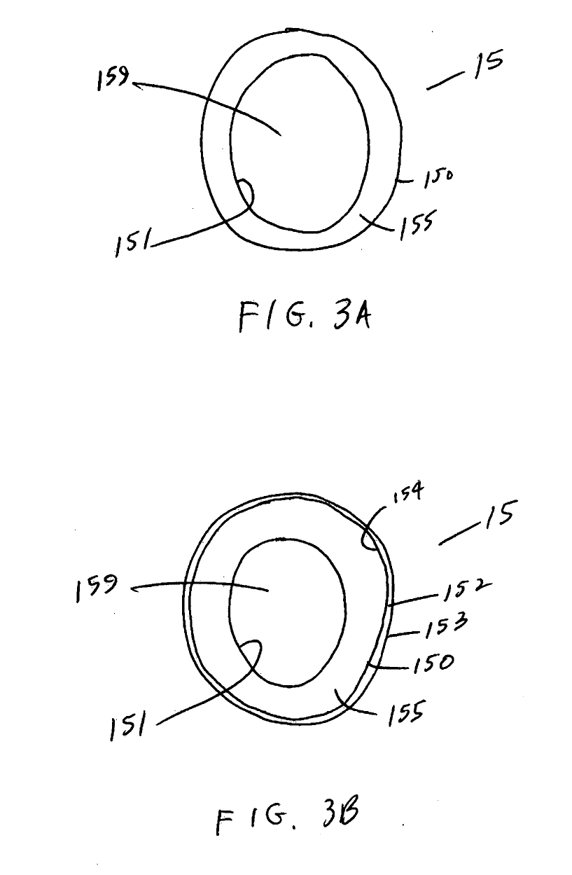

FIG. 3A depicts an exemplary cross-sectional view of exemplary tubing 15 of FIG. 1 along line B-B, which provides an indication of the simplicity of this piece of durable medical equipment. As shown in FIG. 3A, exemplary tubing 15 comprises first thermoformed polymeric structure 155 having outer surface 150 and inner surface 151 facing empty space 159 of exemplary tubing 15. First thermoformed polymeric structure 155 can have at least one anti-microbial agent distributed throughout a thickness of the thermoformed polymeric structure extending from outer surface 150 to inner surface 151. In other embodiments, first thermoformed polymeric structure 155 has at least one anti-microbial agent along outer surface 150, but inner surface 151 of first thermoformed polymeric structure 155 is substantially free of an anti-microbial agent (e.g., by co-extruding an outer layer with anti-microbial material and an inner layer without anti-microbial material).

Another exemplary cross-sectional view of exemplary tubing 15 along line B-B is shown in FIG. 3B. In this exemplary embodiment, exemplary tubing 15 comprises first thermoformed polymeric structure 155 and a second thermoformed polymeric structure in the form of a film 152 extending along an outer portion (i.e., surface 150) of first thermoformed polymeric structure 155 so as to form outer surface 153. In this exemplary embodiment, first thermoformed polymeric structure 155 of exemplary tubing 15 may be substantially free of an anti-microbial agent, and instead be shielded from microorganisms by film 152. Film 152 can have at least one anti-microbial agent distributed throughout a thickness of the thermoformed polymeric structure extending from outer surface 153 to inner surface 154 of film 152. In other embodiments, both first thermoformed polymeric structure 155 and film 152 have at least one anti-microbial agent so that anti-microbial agent extends from outer surface 153 of film 152 to inner surface 151 of first thermoformed polymeric structure 155.

B. Durable Medical Equipment Materials

The various pieces of durable medical equipment of the present invention may comprise one or more of the following materials.

1. Polymeric Matrix Material

The above-described thermoformed polymeric structures (e.g., outer housing 111, first thermoformed polymeric structure 155, and films 115 and 152) comprise a polymeric matrix material in which to at least partially distribute one or more anti-microbial agents. Suitable polymeric matrix materials for forming the thermoformed polymeric structures used in the durable medical equipment of the present invention include, but are not limited to, polyethylene, polypropylene, polyolefin, polyester, polybutylene, polyethylene terephthalate, polyamide, and combinations thereof.

2. Anti-Microbial Material

The thermoformed polymeric structures further comprise one or more anti-microbial components. The one or more anti-microbial components are positioned within and/or on an outer surface of the thermoformed polymeric structure. Suitable anti-microbial components include, but are not limited to, transition metals, transition metal oxides, transition metal salts, transition metal compounds, or a combination thereof. The anti-microbial components typically are on an outer surface of the above-described thermoformed polymeric structures. The anti-microbial components can be in the form of solid particles or layers of one or more anti-microbial components within the thermoformed polymeric structure. Where layered anti-microbial components are employed, the components may be produced by methods such as plasma spraying, liquid spraying, sputtering, incipient wetness, gas phase impregnation, electroless plating, precipitation, and absorption.

The anti-microbial components are desirably selected from transition metals, transition metal oxides, insoluble or slightly soluble transition metal salts or compounds, or mixtures thereof from Groups 3-12 of the Periodic Table. Examples of transition metals suitable for use in the present invention include, but are not limited to, Sc, Sn (as used herein, “Sn” includes all oxidation states of Sn even if a given oxidation state is not technically a transition metal), Ti, V, Cr, Mn, Fe, Co, Ni, Cu, Zn, Y, Zr, Nb, Mo, Tc, Ru, Rh, Pd, Ag, Cd, Hf, Ta, W, Re, Os, Ir, Pt, Au, Hg, Rf, Db, Sg, Bh, Hs, Mt, Uun, Uuu, Uub, and combinations thereof. In one desired embodiment of the present invention, the anti-microbial component comprises Ag, Cu, Zn, or combinations thereof with Ag, Cu or combinations thereof being even more desirable. Examples of transition metal oxides suitable for use in the present invention include, but are not limited to, oxides of Ag, Cu, Zn and Sn, desirably, oxides of Ag, Cu and Zn, and more desirably, oxides of Ag and Cu. In addition, alloys of transition metals such as CuZn manufactured by KDF Fluid Treatment, Inc. (Detroit, Mich.) may be used as the anti-microbial component in the present invention.

Examples of transition metal salts suitable for use in the present invention include, but are not limited to, AgCl, AgBr, AgI, Ag₂S, Ag₃PO₄, NaAg₂PO₄, CuS, and NaCuPO₄. Other examples of silver compounds include, but are not limited to, AgNO₃, Ag₂CO₃, AgOAc, Ag₂SO₄, Ag₂O, [Ag(NH₃)₂]Cl, [Ag(NH₃)₂]Br, [Ag(NH₃)₂]I, [Ag(NH₃)₂]NO₃, [Ag(NH₃)₂]₂SO₄, silver acetoacetate, a silver benzoate, a silver carboxylate, silver amine complexes such as [Ag(NR₃)₂]X, where R is an alkyl or aryl group or substituted alkyl or aryl group and X is an anion such as, but not limited to, Cl⁻, Br⁻, I⁻, OAc⁻, NO₃⁻and SO₄²⁻. Examples of copper compounds include, but are not limited to Cu(NO₃)₂, CuCO₃, CuSO₄, CuCl₂, CuBr₂, CuI₂, CuO, Cu₂O, CuI, Cu(OAc)₂, copper acetoacetate, copper gluconate, a copper benzoate, a copper carboxylate, copper amine complexes such as [Cu(NR₃)₂]X₂, where R is an alkyl or aryl group or substituted alkyl or aryl group and X is an anion such as, but not limited to, Cl⁻, Br⁻, I⁻, OAc⁻, NO₃⁻SO₄²⁻.

The transition metals, transition metal oxides or transition metal salts may be employed in a wide range of sizes depending on the specific application. When used in the thermoformed polymeric structures, the transition metals, transition metal oxides or transition metal salts are desirably nanoparticles having an average particle size ranging from about 0.1 nm to about 10,000 nm, more desirably, from about 1 nm to about 1000 nm, and even more desirably, from about 2 nm to about 500 nm diameter. Alternatively, the transition metals, transition metal oxides or metal salts may be bulk material (i.e. larger than nanoparticles). For example, the transition metals, transition metal oxides or metal salts may be supplied in particle sizes up to several millimeters (mm).

The anti-microbial components (e.g., the above-described metals, metal oxides, and/or transition metal salts or compounds) may be present in an amount of up to about 15 weight percent (wt %) based on a total weight of the thermoformed polymeric structure (i.e., the polymeric matrix material, the anti-microbial components, and any other additives). Desirably, the anti-microbial components are present in an amount ranging from about 0.01 wt % to about 15 wt %, more desirably from about 0.1 wt % to about 7.4 wt %, even more desirably from about 0.2 wt % to about 4.8 wt %, and even more desirably from about 0.35 wt % to about 3.5 wt % based on a total weight of the thermoformed polymeric structure.

In one desired embodiment of the present invention, the thermoformed polymeric structure comprises a mixture of Ag/Cu, Ag/Zn, Ag/Sn or Ag/Ni. More desirably, the thermoformed polymeric structure comprises a mixture of Ag and Cu nanoparticles having an average particle size ranging from about 0.1 nm to about 10,000 nm, more desirably from about 1 nm to about 1000 nm, even more desirably from about 2 nm to about 500 nm. In this desired embodiment, the ratio of Ag to Cu in the mixture may vary from a weight ratio of about 100:1 (Ag:Cu), desirably about 10:1 to about 1:5 (Ag:Cu), more desirably about 1:1 (Ag:Cu).

In another desired embodiment of the present invention, the thermoformed polymeric structure comprises a mixture of Ag and Cu nanoparticles on a support material, such as an alumina or zeolite support material. In this embodiment, the silver nanoparticles have a median size of about 20 nm and the copper nanoparticles have a median size of about 100 nm. Each of the silver nanoparticles and the copper nanoparticles may be present in the mixture in an amount ranging from about 0.2 wt % to about 4.8 wt %, desirably about 0.5 wt % to about 4.5 wt %, more desirably about 0.7 wt % to about 4.0 wt % based on a total weight of the anti-microbial material (i.e., the anti-microbial agent and the support material). In one desired embodiment, the anti-microbial material comprises a 1:1 mixture (i.e., 1:1 weight ratio) of Ag nanoparticle and Cu nanoparticle on an alumina or zeolite support material.

In a further desired embodiment of the present invention, the anti-microbial material comprises a mixture of silver oxide and copper oxide on a support material, such as an alumina or zeolite support material. Useful copper oxides include both cuprous oxide and cupric oxide with cuprous oxide being the preferred oxide. The amounts of silver oxide and copper oxide may vary over a wide range. Typically, each of the silver oxide and copper oxide is present in an amount of about 0.1 wt % to about 2.0 wt %, desirably from about 0.5 wt % to about 1.5 wt %, more desirably from about 0.7 wt % to about 1.0 wt % based on a total weight of the anti-microbial material (i.e., the anti-microbial agent and the support material). The purities of silver oxide and copper oxide may vary over a wide range. Typically, the oxides are about 80 wt % to about 99.999 wt % pure, desirably about 90 wt % pure to about 99.99 wt % pure, more desirably about 98 wt % to about 99.99 wt % pure.

In yet a further embodiment of the present invention, the anti-microbial material comprises a mixture of silver and copper metal nanoparticles in combination with nanoparticles of one or more additive metals or metal oxides from Groups 2-13 of the Periodic Table. The additive metals may be Sc, Ti, V, Sn, Cr, Mn, Fe, Co, Ni, Zn, Y, Zr, Nb, Mo, Tc, Ru, Rh, Pd, Cd, Hf, Ta, W, Re, Os, Ir, Pt, Au, Hg, Rf, Db, Sg, Bh, Hs, Mt, Uun, Uuu or Uub. Desirably, the additive metals comprise Zn, Sn, Ni, more desirably Zn and Sn. The additive metal oxides may be oxides such as alumina and silica, as well as oxides of silver, titanium, tin, lanthanum, copper, vanadium, manganese, nickel, iron, zinc, zirconium, magnesium, thorium, or a combination thereof. Desirably, the additive metal oxides are oxides of silver, copper, tin, zinc, or nickel, more desirably silver. The additive metal or metal oxide may be present in an amount ranging from about 0.01 wt % to about 99.9 wt %, desirably from about 0.1 wt % to about 10 wt %, more desirably from about 1.0 wt % to about 5.0 wt % based on a total weight of the mixture (i.e., the anti-microbial material). In this embodiment, the combined weight of silver and copper in the mixture is from about 0.1 wt % to about 5.0 wt %, and the weight of additive metal or metal oxide is from about 0.05 wt % to about 5.0 wt % based on a total weight of the anti-microbial material.

3. Additives

Any of the above-described thermoformed polymeric structures may further comprise one or more additives on an outer surface thereof and/or distributed throughout the thermoformed polymeric structure. Suitable additives include, but are not limited to, colorants, additives to increase the coefficient of friction of a given component layer, additives to increase the hydrophilicity of a given component layer, etc.

The various additives may be added to a polymer melt, along with one or more anti-microbial agents, and extruded to incorporate the additive into a thermoformed polymeric structure. Alternatively, one or more additives may be coated onto a thermoformed polymeric structure during or after a thermoforming process. Typically, when present, each of the one or more additives is present in an amount less than about 25 weight percent, desirably, up to about 2.5 percent, based on the total weight of the thermoformed polymeric structure.

II. Methods of Making Durable Medical Equipment

The present invention is further directed to methods of making durable medical equipment. Any of the above-described individual pieces of durable medical equipment of the present invention may be formed using conventional methods. For example, thermoformed polymeric structures (e.g., housing 111 or film 115) may be formed via any thermoforming process including, but not limited to, molding processes such as injection molding, and film-forming processes such as a film extrusion process or a film-blowing process. One or more antimicrobial agents can be added to a polymer melt or a solution containing polymeric material prior to or during a thermoforming step in any of the above-mentioned thermoforming processes.

In one exemplary method of making a piece of durable medical equipment suitable for use in an operating room setting, a hospital, or any other medical facility, the method comprises the steps of forming at least one component of the piece of durable medical equipment, the at least one component having an outer surface that is exposed to body fluids and other fluids when the piece of durable medical equipment is in an operating room setting, a hospital, or any other medical facility, wherein the outer surface comprises a polymeric matrix material and at least one anti-microbial agent within the polymeric matrix material, the at least one anti-microbial agent being selected from the group consisting of a Ag-containing compound, a Cu-containing compound, or combinations thereof; and if the piece of durable medical equipment has additional components, assembling the at least one component and the additional components so that the outer surface of the piece of durable medical equipment is exposed to body fluids and other fluids when the piece of durable medical equipment is in an operating room setting, a hospital, or any other medical facility.

In one desired embodiment of the above method, the piece of durable medical equipment comprises a compression sleeve pump, the at least one component comprises an outer pump housing, and the additional components comprise inner pump components within the outer pump housing.

The above method may further comprise a number of additional steps. In one exemplary embodiment, the method further comprises the steps of forming a kit comprising the compression sleeve pump in combination with one or more additional pieces of durable medical equipment, wherein the one or more additional pieces comprise at least one compression sleeve, at least one foot sleeve, first tubing suitable for connecting the compression sleeve pump to the at least one compression sleeve, second tubing suitable for connecting the compression sleeve pump to the at least one foot sleeve, tubing connectors, or any combination thereof. The kit may comprise a tubular compression sleeve (e.g., a compression sleeve that has a tubular configuration and is slipped over a body part (e.g., a leg portion)), a wrap-around compression sleeve (e.g., a compression sleeve that has a sheet-like configuration and is wrapped around a body part and then attached to itself in order to form an inflatable sleeve positioned about the body part), or a combination thereof.

III. Methods of Using Durable Medical Equipment

The present invention is further directed to methods of using a piece of durable medical equipment in an operating room setting, a hospital, or any other medical facility. In one exemplary embodiment, the method comprises the steps of introducing the above-described compression sleeve pump, kit or piece of durable medical equipment into an operating room setting, a hospital, or any other medical facility; and utilizing the compression sleeve pump, kit or piece of durable medical equipment to provide a function to a patient (e.g., treat DVT, monitor a patient's vital statistics, provide comfort to a patient, etc.).

While the specification has been described in detail with respect to specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

What is claimed is:

1. A compression sleeve pump suitable for use in an operating room setting, a hospital, or any other medical facility, said compression sleeve pump having an outer surface that is exposed to body fluids and other fluids when said compression sleeve pump is in an operating room setting, a hospital, or any other medical facility, said outer surface comprising at least one anti-microbial agent.

2. The compression sleeve pump of claim 1, wherein said compression sleeve pump comprises inner pump components within an outer pump housing, said outer pump housing comprising a thermoformed polymeric structure comprising said outer surface.

3. The compression sleeve pump of claim 2, wherein said at least one anti-microbial agent is distributed throughout a thickness of said thermoformed polymeric structure.

4. The compression sleeve pump of claim 2, wherein an inner surface of said outer pump housing facing said inner pump components is substantially free of said at least one anti-microbial agent.

5. The compression sleeve pump of claim 1, wherein said thermoformed polymeric structure comprises a film along an outer portion of said outer pump housing so as to form said outer surface.

6. The compression sleeve pump of claim 2, wherein said thermoformed polymeric structure comprises a polymeric material selected from the group consisting of polyethylene, polypropylene, polyolefin, polyester polybutylene, polyethylene terephthalate, polyamide, and combinations thereof.

7. The compression sleeve pumps of claim 1, wherein said at least one anti-microbial agent comprises an Ag-containing compound, a Cu-containing compound, or combinations thereof.

8. The compression sleeve pump of claim 7, wherein said silver-containing compound comprises a silver-containing compound.

9. A kit comprising the compression sleeve pump of claim 1 in combination with one or more additional pieces of durable medical equipment, wherein said one or more additional pieces comprise at least one compression sleeve, at least one foot sleeve, first tubing suitable for connecting said compression sleeve pump to said at least one compression sleeve, second tubing suitable for connecting said compression sleeve pump to said at least one foot sleeve, tubing connectors, or any combination thereof.

10. The kit of claim 9, wherein each of said one or more additional pieces has an outer piece surface that is exposed to body fluids and other fluids when said one or more additional pieces is in an operating room setting, said outer piece surface comprising at least one anti-microbial agent.

11. A piece of durable medical equipment suitable for use in an operating room setting, a hospital, or any other medical facility, said piece of durable medical equipment having an outer surface that is exposed to body fluids and other fluids when said piece of durable medical equipment is in an operating room setting, a hospital, or any other medical facility, said outer surface comprising a polymeric matrix material and at least one anti-microbial agent within said polymeric matrix material, said at least one anti-microbial agent being selected from the group consisting of a Ag-containing compound, a Cu-containing compound, or combinations thereof.

12. The piece of durable medical equipment of claim 11, wherein said piece of durable medical equipment comprises a compression sleeve pump.

13. The piece of durable medical equipment of claim 11, wherein said piece of durable medical equipment comprises inner piece components within an outer housing, said outer housing comprising a thermoformed polymeric structure comprising said outer surface and an inner surface facing said inner piece components.

14. The piece of durable medical equipment of claim 13, wherein said at least one anti-microbial agent is distributed throughout a thickness of said thermoformed polymeric structure.

15. The piece of durable medical equipment of claim 11, wherein said thermoformed polymeric structure comprises a film along an outer portion of said outer housing so as to form said outer surface.

16. The piece of durable medical equipment of claim 11, wherein said polymeric matrix material is selected from the group consisting of polyethylene, polypropylene, polyolefin, polyester polybutylene, polyethylene terephthalate, polyamide, and combinations thereof.

17. A method of making a piece of durable medical equipment suitable for use in an operating room setting, a hospital, or any other medical facility, said method comprising the steps of:
forming at least one component of the piece of durable medical equipment, the at least one component having an outer surface that is exposed to body fluids and other fluids when the piece of durable medical equipment is in an operating room setting, a hospital, or any other medical facility, wherein the outer surface comprises a polymeric matrix material and at least one anti-microbial agent within said polymeric matrix material, said at least one anti-microbial agent being selected from the group consisting of a Ag-containing compound, a Cu-containing compound, or combinations thereof; and
if the piece of durable medical equipment has additional components, assembling the at least one component and the additional components so that the outer surface of the piece of durable medical equipment is exposed to body fluids and other fluids when the piece of durable medical equipment is in an operating room setting, a hospital, or any other medical facility.

18. The method of claim 17, wherein the piece of durable medical equipment comprises a compression sleeve pump, the at least one component comprises an outer pump housing, and the additional components comprise inner pump components within the outer pump housing.

19. The method of claim 18, further comprising the steps of:
forming a kit comprising the compression sleeve pump in combination with one or more additional pieces of durable medical equipment, wherein said one or more additional pieces comprise at least one compression sleeve, at least one foot sleeve, first tubing suitable for connecting said compression sleeve pump to said at least one compression sleeve, second tubing suitable for connecting said compression sleeve pump to said at least one foot sleeve, tubing connectors, or any combination thereof.

20. A method of using a piece of durable medical equipment in an operating room setting, a hospital, or any other medical facility, comprising the steps of:
introducing the compression sleeve pump, kit or piece of durable medical equipment of claim 1 into an operating room setting, a hospital, or any other medical facility; and
utilizing the compression sleeve pump, kit or piece of durable medical equipment to provide a function to a patient.
